(19) United States
(12) Patent Application Publication
(10) Pub. No.: US 2020/0018178 A1
(43) Pub. Date: Jan. 16, 2020

(54) GAS TURBINE ENGINE OUTLET GUIDE VANES

(71) Applicant: ROLLS-ROYCE plc, London (GB)

(72) Inventor: Steven A RADOMSKI, Nottingham (GB)

(73) Assignee: ROLLS-ROYCE plc, London (GB)

(21) Appl. No.: 16/451,792

(22) Filed: Jun. 25, 2019

(30) Foreign Application Priority Data
Jul. 13, 2018 (GB) 1811491.8

(51) Int. Cl. F01D 9/04; F02K 3/06; F02C 7/36

(52) U.S. Cl. CPC F01D 9/041; F02K 3/06; F02C 7/36; F05D 2260/31; F05D 2250/70; F05D 2260/40311; F05D 2240/12

(57) ABSTRACT

The present disclosure relates to outlet guide vanes in a gas turbine engine, and in particular to such vanes with particular ranges of relative dimensions. Example embodiments include a gas turbine engine (10) comprising a plurality of outlet guide vanes (31) each having a length extending across a bypass duct (22) of the gas turbine engine (10), wherein for each outlet guide vane a minimum thickness to chord ratio is less than 80% of a maximum thickness to chord ratio.

### CROSS-REFERENCE TO RELATED APPLICATIONS

This specification is based upon and claims the benefit of priority from UK Patent Application Number 1811491.8 filed on 13 Jul. 2018, the entire contents of which are incorporated herein by reference.

### BACKGROUND

The present disclosure relates to outlet guide vanes (OGVs) in a gas turbine engine, and in particular to outlet guide vanes with particular ranges of relative dimensions.

### SUMMARY

According to a first aspect there is provided a gas turbine engine comprising a plurality of outlet guide vanes each having a length extending across a bypass duct of the gas turbine engine, wherein for each outlet guide vane a minimum thickness to chord ratio is less than 80% of a maximum thickness to chord ratio.

The maximum thickness to chord ratio of the guide vane may be at the inner or outer face of the bypass duct, corresponding to a root and tip respectively of the guide vane.

The thickness to chord ratio at any point along the length of an outlet guide vane may be defined by a ratio between a maximum thickness across the outlet guide vane and a maximum chord length across the outlet guide vane.

It will be appreciated that the thickness to chord ratio of the outlet guide vane varies along its length (or span). Thus, a cross-section through the outlet guide vane at a given spanwise position (or length between the root and tip) has a generally aerofoil shape having a thickness and chord defined in the conventional manner (i.e. the thickness is the maximum thickness of that cross-section). The thickness to chord ratio is thus defined for each cross-section through the vane using the local thickness and chord at that cross-section. Thus, the minimum thickness to chord ratio for the vane is defined at the cross-section for which the value of the local thickness divided by the local chord is a minimum. Similarly, the maximum thickness to chord ratio for the vane is defined at the cross-section for which the value of the local thickness divided by the local chord is a maximum.

The variation in thickness to chord ratio allows the OGVs of a gas turbine engine to provide more of a structural component for the engine, resulting in the ability to make the engine axially more compact. This may be achieved by thickening the root, and optionally the tip, of each OGV so that an increased loading, both axially and in torsion, can be applied to each vane. Thickening the tip in particular allows a stiffer interface between the outlet guide vane and an end attachment of the vane. A different type of joint may then be made with the outer casing of the bypass duct by bolting the end attachment to the outer casing, rather than by a conventional pin jointed attachment. By bolting the tip to the outer casing with a plurality of bolts, the connection between each vane and the outer casing can be made to support a greater torque loading between the inner and outer faces of the bypass duct. This may allow for structural supporting vanes to be omitted, and the entire torque loading to be transmitted via the guide vanes alone.

The minimum thickness to chord ratio of the guide vane may be at a position along the length of the guide vane of between around 85% and 95% from the inner to outer faces of the bypass duct. Varying the ratio in this way allows for an efficient way of increasing tangential stiffness of the vane for only a small detrimental effect in terms of aerodynamic loss, as the increase in thickness is concentrated towards the tip of the guide vane, in a region where there is greater room for the passage of air flow through the bypass duct.

At a root of each guide vane, i.e. at an inner surface of the bypass duct, the thickness to chord ratio may be between around 0.06 and 0.08, or optionally between 0.065 and 0.075.

At a tip of each guide vane, i.e. at an outer surface of the bypass duct, the thickness to chord ratio may be between around 0.06 and 0.08, or optionally between 0.065 and 0.075.

In some embodiments, the minimum thickness to chord ratio over the length of each vane may be between around 65% and 75% of the maximum thickness to chord ratios.

A maximum thickness of each outlet guide vane may vary along the length of the outlet guide vane by more than 30% around a mean value of the maximum thickness of the outlet guide vane, and optionally may be between around 30% and 35% around the mean value.

The chord length of each outlet guide vane may vary along the length of the outlet guide vane by between about 15% and 25% around a mean value of the chord length for the outlet guide vane.

According to a second aspect there is provided a gas turbine engine of the first aspect for an aircraft, the gas turbine engine comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft.

In the gas turbine engine, the turbine may be a first turbine, the compressor a first compressor, and the core shaft a first core shaft, the engine core further comprising a second turbine, a second compressor, and a second core shaft connecting the second turbine to the second compressor, the second turbine, second compressor, and second core shaft being arranged to rotate at a higher rotational speed than the first core shaft.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a close up sectional side view of an upstream portion of a gas turbine engine;

FIG. 3 is a partially cut-away view of a gearbox for a gas turbine engine; and

FIG. 4 is a schematic plot of thickness to chord ratio for two example outlet guide vanes;

FIG. 5 is a schematic plot of maximum thickness for the two example outlet guide vanes of FIG. 4; and

FIG. 6 is a schematic plot of chord length for the two example outlet guide vanes of FIG. 4 and FIG. 5

### DETAILED DESCRIPTION OF THE DISCLOSURE

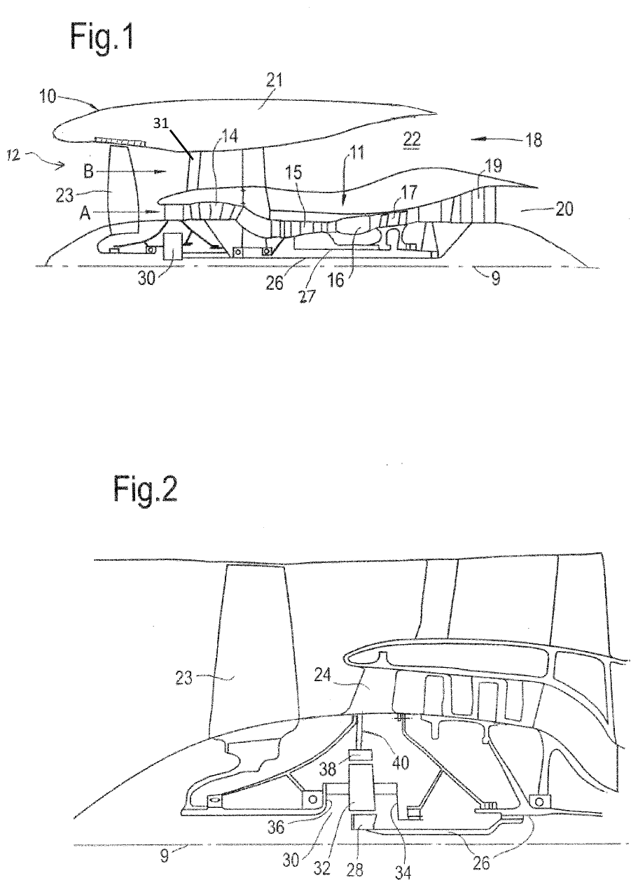

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

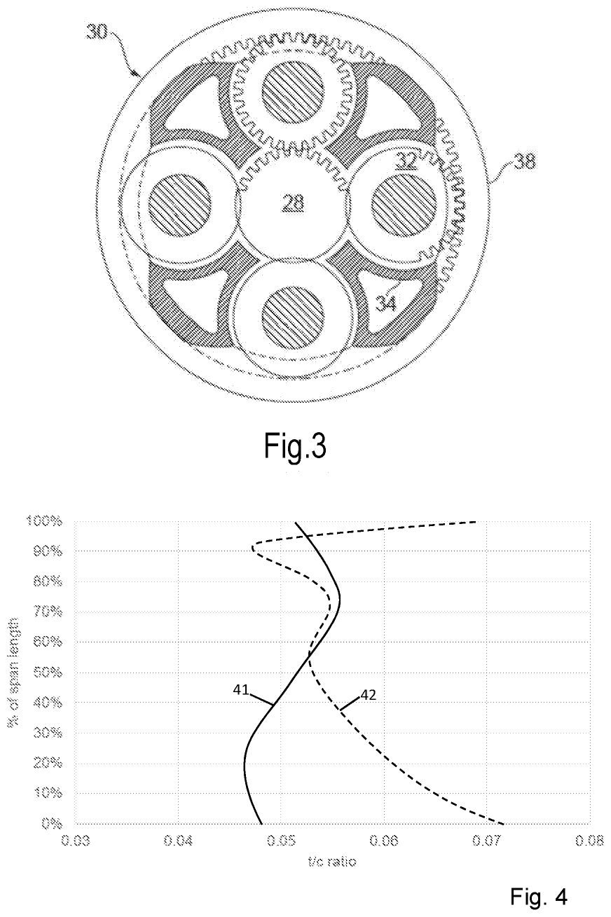

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

In a gas turbine engine 10 such as that illustrated in FIG. 1, outlet guide vanes 31 are provided in the bypass duct 22 and function primarily to counteract rotational air movement in the bypass airflow B caused by rotation of the upstream fan blades 23. OGVs are therefore conventionally designed primarily based on aerodynamic rather than structural considerations, typically resulting in the vanes 31 being relatively thin at the root. Structural support across the bypass duct 22 may instead be provided by a number of structural support vanes. The ratio between the thickness and the chord dimensions of a typical guide vane will tend to vary along its length. An example is illustrated in FIG. 4, in which the thickness to chord ratio 41 for a typical guide vane is shown. The ratio averages around 0.051 between the root and tip of the guide vane, with the ratio being a minimum of around 0.046 in the inner half of the length from the root to the tip and a maximum of around 0.056 in the outer half. The ratio from the root to the tip follows a roughly sinusoidal shape with a roughly linear offset making the ratio at the tip greater than that at the root. The ratio along the length of the guide vane as a result varies by no more than around +/−10% from the mean for this example.

FIG. 4 also shows a plot 42 of the variation in thickness to chord ratio for an example vane according to the present disclosure. The ratio at the root, i.e. at 0% of the span length, is substantially greater than that for the conventional guide vane, being between around 0.065 and 0.075 compared to between 0.045 and 0.05 for the conventional guide vane. In a general aspect, the thickness to chord ratio at the root of the guide vane may be between around 0.06 and 0.08, and optionally between 0.065 and 0.075. The ratio at the tip may also be substantially greater that that towards the middle of the vane. In the illustrated example, the ratio at the tip is around 0.068. In a general aspect, the thickness to chord ratio at the tip of the guide vane may be between around 0.06 and 0.08, and optionally between 0.065 and 0.075.

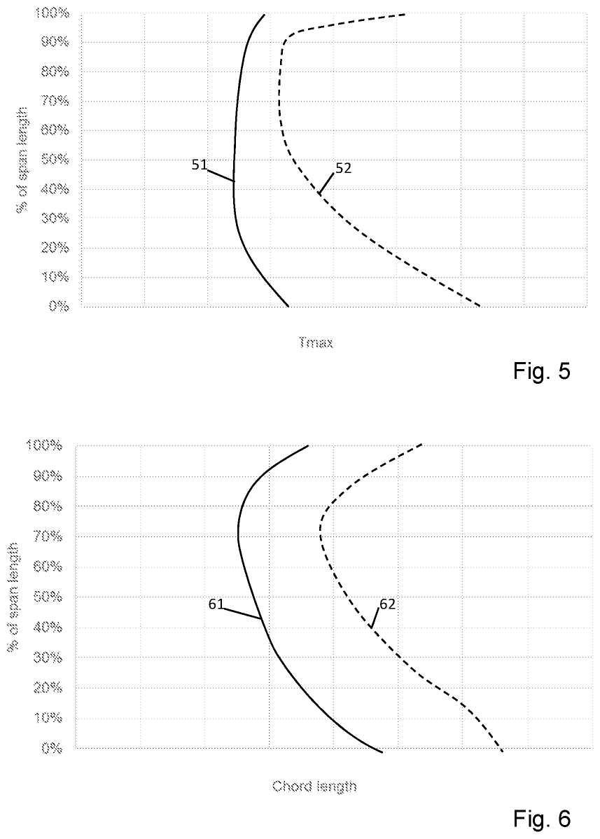

As also shown in FIG. 4, the minimum thickness to chord ratio for the example guide vane is around 0.047 at around 90% of the thickness from the root to the tip. This results from the thickness being roughly constant between around 60% and 90% as shown in FIG. 5, while the chord length reaches a minimum at around 70-75% and increases towards the tip of the vane, as shown in FIG. 6. In a general aspect therefore, the minimum thickness to chord ratio over the length of the vane may be less than around 80% of the maximum ratio, optionally between around 60% to 80% of the maximum thickness to chord ratio, and further optionally between around 65% to 75% or between 65% and 70%. This compares with the minimum ratio of the conventional guide vane being around 85% of the maximum ratio, corresponding to substantially less variation in the thickness to chord ratio along the length of the vane.

The variation in thickness to chord length ratio may be primarily achieved by making the vane thickness substantially greater towards the root and tip, as shown in the plot of maximum vane thickness Tmax over the vane length in FIG. 5, in which the typical example guide vane variation in thickness 51 is compared with the thickness 52 of the example according to the present disclosure. Whereas the conventional guide vane thickness 51 varies by about +/−20% around a mean value, the example guide vane thickness 52 varies by about +/−33% around a mean value. The mean value may vary according to the particular application and size of engine in which the guide vanes are used. The chord length, on the other hand, as shown in FIG. 6, varies across the length of the guide vanes by similar amounts to that in the conventional guide vane. The chord length 61 of the conventional guide vane varies by about +/−20% around a mean value, and the chord length 62 of the example guide vane also varies by about +/−20% around a mean value.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A gas turbine engine comprising a plurality of outlet guide vanes each having a length extending across a bypass duct of the gas turbine engine, wherein for each outlet guide vane a minimum thickness to chord ratio is less than 80% of a maximum thickness to chord ratio.

2. The gas turbine engine of claim 1 wherein the maximum thickness to chord ratio of each outlet guide vane is at an inner face of the bypass duct.

3. The gas turbine engine of claim 1 wherein the maximum thickness to chord ratio of each outlet guide vane is at an outer face of the bypass duct.

4. The gas turbine engine of claim 1 wherein each guide vane is bolted to an outer casing of the bypass duct with a plurality of bolts.

5. The gas turbine engine of claim 1 wherein a minimum thickness to chord ratio of each guide vane is at a position along the length of the outlet guide vane of between around 85% and 95% from the inner to outer faces of the bypass duct.

6. The gas turbine engine of claim 1 wherein the thickness to chord ratio at a root of each guide vane, at an inner surface of the bypass duct, is between around 0.06 and 0.08.

7. The gas turbine engine (10) of claim 6 wherein the thickness to chord ratio at the root of each guide vane is between around 0.065 and 0.075.

8. The gas turbine engine of claim 1 wherein the thickness to chord ratio at a tip of each guide vane, at an outer surface of the bypass duct, is between around 0.06 and 0.08.

9. The gas turbine engine of claim 8 wherein the thickness to chord ratio at the tip of each guide vane is between around 0.065 and 0.075.

10. The gas turbine engine of claim 1 wherein the minimum thickness to chord ratio over the length of each vane is between around 65% and 75% of the maximum thickness to chord ratio.

11. The gas turbine engine of claim 1 wherein a maximum thickness of each outlet guide vane varies along the length of the outlet guide vane by more than 30% around a mean value of the maximum thickness of the outlet guide vane.

12. The gas turbine engine of claim 11 wherein the maximum thickness of each guide vane varies along the length of the outlet guide vane by between 30% and 35% around the mean value.

13. The gas turbine engine of claim 1 wherein the chord length of each outlet guide vane varies along the length of the outlet guide vane by between 15% and 25% around a mean value of the chord length for the outlet guide vane.

14. The gas turbine engine of claim 1 for an aircraft, the gas turbine engine comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft.

15. The gas turbine engine according to claim 14, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.
